(19) United States
(12) Patent Application Publication
(10) Pub. No.: US 2002/0180811 A1
(43) Pub. Date: Dec. 5, 2002

(54) Systems, methods, and articles of manufacture for providing a user interface with selection and scrolling

(76) Inventor: Sing Yun Chu, Mountain View, CA (US)

Correspondence Address: Finnegan, Henderson, Farabow, Garrett & Dunner, L.L.P., 1300 I Street, N.W., Washington, DC, 20005-3315, US

(21) Appl. No.: 10/011,391

(22) Filed: Dec. 11, 2001

Related U.S. Application Data
(60) Provisional application No. 60/294,297, filed on May 31, 2001.

(51) Int. Cl. G09G 5/00

(52) U.S. Cl. 345/856

(57) ABSTRACT

Methods, system, and articles of manufacture consistent with certain feature related to the present invention allow a computing device including an interactive display device to distinguish between pointer events. The computing device may determine a position displacement associated with a user-controlled pointer interaction with the display device and compare the position displacement with an error threshold value to determine a type of operation to perform on the display device.

### BACKGROUND OF THE INVENTION

Applicant herby claims the benefit of priority of U.S. Provisional Patent Application No. 60/294,297, filed May 31, 2001, which is incorporated herein by reference.

1. Field of the Invention

The present invention relates generally to user interfaces and more particularly to systems and methods for providing a user interface with selection and scrolling.

2. Description of Related Art

A user interface is a sensory facility used to enable users to input commands and data to interactive computing devices, such as mobile telephones, personal digital assistants, and computers. The functioning of user interfaces is critical in the operation of these devices. Known user interfaces include Motif™, OpenLook™, Microsoft™ Windows, various Apple™ Macintosh™ windowing user interfaces, and the PalmOS™.

In the user interface for a personal digital assistant (PDA), such as PalmOS™, a stylus, pen, or pointer mechanism (“pointer”), or an operator's finger is used to point to a location on a display screen. By pressing the pointer at the location of a textual or graphical representation on the display screen, the textual or graphical representation may be manipulated. For example, when a PDA displays a textual or graphical representation forming a dialog box having a “dismiss” button and a user selects the dismiss button, the PDA receives a signal indicating selection of the dismiss button and performs the corresponding operation. In this example, the PDA displays an image of a dismiss button at a predetermined location on the display screen as specified by at least one (x, y) Cartesian coordinate. Further, a pointer-down event (e.g., pressing the pointer on the display screen) corresponds to an (x, y) coordinate at which a pointer-down event occurs on the display screen. Other events, such as a pointer-up event are used to determine whether a user has removed the pointer from a surface of the display screen.

Responsiveness of a user interface is also important in the operation of a device. Inaccurate responses may occur when a device or its user interface incorrectly interprets user inputs. Access attempts, for instance, may be misinterpreted due to surrounding physical conditions or user infirmity that may cause a user to shake or move during an access attempt, such as Parkinson's disease. The interactive computing device may misinterpret the access attempts made by the user due to the unintentional movement, causing unintended responses by the device. These unintended responses may be misconstrued by the user as a malfunction of the device.

A PDA device may experience movement that causes a displacement in the position of a pointer with respect to a display screen providing a user interface (“input displacement”). Such an input displacement may cause the device to misinterpret user inputs, thus, causing undesired operations by the device.

As explained above, user interfaces interpret user operations as events triggering or invoking a process to be performed by the corresponding device. For example, the user can use the pointer with certain user interfaces to perform operations. A selection operation may be implemented with a pointer event by pressing the pointer on the display (“pointer-down event”) and then lifting the pointer from the display (“pointer-up event”) at an appropriate location. A scroll operation may be implemented with a pointer by pressing the pointer on the display and dragging the pointer across the display. A device may misinterpret an intended selection operation as a scroll operation if there is unintentional input displacement in the pointer during an intended selection operation. This misinterpretation may be frustrating to users, and further may cause inefficient use of a device.

### SUMMARY OF THE INVENTION

It is therefore desirable to have a method and system that enables an interactive computing device to distinguish between intentional and unintentional user inputs on a user interface.

Methods, systems, and articles of manufacture consistent with certain principles related to the present invention may distinguish between user operations for an interactive display device by detecting interactions between a user-controlled pointer and the interactive display device to establish pointer events; measuring a position displacement as a distance between a first pointer event and a second pointer event; and comparing the position displacement to an error threshold to identify the desired user operation.

Additionally, methods, system, and articles of manufacture consistent with the present invention may adjust an error threshold based on a decay time associated with established pointer events. The error threshold may be used to determine types of user operations associated with the interactive display device.

Both the foregoing general description and the following detailed description are exemplary and explanatory only and do not restrict the invention, as claimed.

### BRIEF DESCRIPTION OF THE DRAWINGS

The accompanying drawings, which are incorporated in and constitute a part of this specification, illustrate exemplary embodiments of the invention and together with the description, serve to explain the principles of the present invention. In the drawings,

FIG. 1 is a diagram showing a device with a user interface consistent with certain aspects related to the present invention;

FIG. 2A is a diagram showing a PDA device including a user interface consistent with certain aspects related to the present invention;

FIG. 2B is a diagram of the PDA of FIG. 2A showing an exemplary contracted widget consistent with certain aspects related to the present invention;

FIG. 2C is a diagram of the PDA of FIG. 2A showing an exemplary expanded widget consistent with certain aspects related to the present invention;

FIG. 3 is a flow diagram illustrating a first portion of an exemplary method for distinguishing between user operations in a manner consistent with certain aspects related to the present invention; and

FIG. 4 is a flow diagram illustrating a second portion of an exemplary method for distinguishing between user operations in a manner consistent with certain aspects related to the present invention.

### DETAILED DESCRIPTION

Methods, systems, and articles of manufacture consistent with certain features related to the present invention enable an interactive computing device to distinguish between user operations associated with a user interface. Methods, systems and articles of manufacture consistent with features of the present invention may perform the above functions by detecting pointer events associated with separate interactions between a user-controlled pointer and a user interface of an interactive computing device.

The device may calculate a pointer displacement based on the position of the user-controlled pointer during respective interactions with the user interface. In one configuration consistent with certain features of the present invention, the device may perform different operations based on an analysis of the calculated displacement and an error threshold.

Additionally, methods, systems, and articles of manufacture consistent with certain features related to the present invention may allow the interactive device to adjust an error threshold based on a time value associated with respective pointer events.

Reference will now be made in detail to an implementation of the present invention illustrated in the accompanying drawings. Wherever possible, the same reference numbers in the drawings refer to the same or like parts.

The above-noted features and other aspects and principles of the present invention may be implemented in various environments. Such environments and related applications may be specially constructed for performing the various processes and operations of the invention or they may include a general-purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

The present invention also relates to computer readable media that include program instruction or program code for performing various computer-implemented operations based on the methods and processes of the invention. The program instructions may be those specially designed and constructed for the purposes of the invention, or they may be of the kind well known and available to those having skill in the computer software arts. Examples of program instructions include for example machine code, such as produced by a compiler, and files containing a high level code that can be executed by the computer using an interpreter.

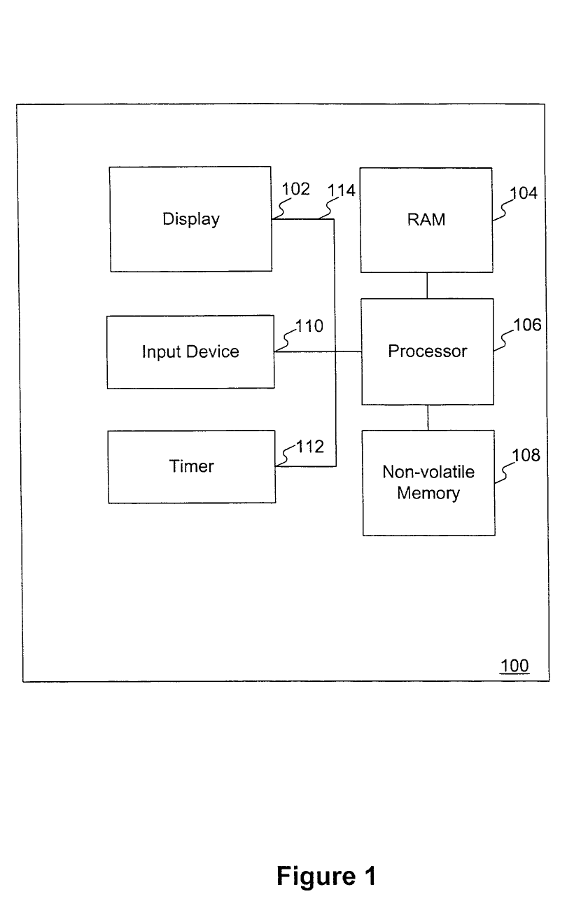

FIG. 1 is a block diagram showing a device 100 in which systems, methods, and articles of manufacture consistent with present invention may be implemented. Device 100 may be a general interactive computing device, such as a pager, mobile phone, PDA, desktop computer, laptop computer, and any known computing device that may implement user interactive operations. In one configuration consistent with the present invention, device 100 may be a handheld computer, such as a PDA e.g., the Palm Pilot™ from Palm Inc. and the Visor™ from Handspring™.

As shown, device 100 includes a display 102, Random Access Memory (“RAM”) 104, input device 110, processor 106, non-volatile memory 108, and timer 112. Display 102 may be a liquid crystal display (“LCD”), a cathode ray tube (“CRT”), and any other type of display known in the art. Display 102 may be coupled to processor 106 by system bus 114.

RAM 104 may be a memory for storing data, instructions, and other types of information that may be executed and/or used by processor 106, and any other element consistent with features of the present invention. Although FIG. 1 shows RAM 104 as a Random Access Memory type storage device one skilled in the art would realize that device 100 may implement other types of semiconductor type storage devices without departing from the scope of the invention.

Processor 106 may be any general-purpose or dedicated processor known in the art that performs logical and mathematical operations consistent with certain features related to the present invention. Processor 106 may exchange information and data with any other element of device 100 through system bus 114. Although FIG. 1 shows only one processor 106 included with device 100, one skilled in the art would realize that a number of different architectures may be implemented by methods, systems, and articles of manufacture consistent with certain features related to the present invention. For example, processor 106 may be replaced, or supplemented, by a plurality of processors that perform multi-tasking operations.

Non-volatile memory 108 may be a non-volatile type storage device that includes instructions that may be executed by processor 106 to perform processes consistent with certain features related to the present invention. Non Volatile Memory 108 may include an Electrically Erasable Programmable Read Only Memory (“EEPROM”), flash memory, or other types of memory that enables information stored thereon to be retained in the event of a fault, such as loss of power.

Input device 110 may be a device for managing the interaction between a user and a widget. A widget may be an element of a user interface displayed on display 102. For example, a widget may include graphical, textual, and alphanumeric images, symbols and icons. Input device 110 may facilitate the exchange of information between a pressure-sensitive user interface, such as those present on a PDA, and the elements of device 100, such as processor 106. For example, input device 110 may manage user input operations associated with display 102 and other input devices, such as a keyboard, mouse, etc. (not shown).

In one configuration consistent with the present invention, input device 110 allows a user to input commands and data to device 100 by recognizing when a user-controlled pointer makes contact with a pressure sensitive portion of display 102. A user-controlled pointer (pointer) may be associated with a stylus, pen, a user's extremity, such as a finger, and any other type of pointing instrument that is separate from the device 100 and may be used by a user to make contact with display 102 or any other user interactive display device consistent with features of the present invention. Timer 112 may be a known clock device, such as a real time clock.

System bus 114 may allow data, information, and instructions to be exchanged between the elements of device 100. System bus 114 may include a serial or parallel data bus, such as a Universal Serial Bus, IEEE 1394. Alternatively, system bus 114 may incorporate wireless data exchange technologies, such as Bluetooth.

It should be noted that the configuration of device 100 shown in FIG. 1 is exemplary and not intended to be limiting. One skilled in the art would recognize that any number of configurations, including additional (or less) components than that shown in the figure, might be implemented without departing from the scope of the present invention. For example, processor 106 may be configured to include RAM 104 and non-volatile memory 108.

In one configuration consistent with certain features related to the present invention, device 100 may allow processor to execute an operating system (“OS”), such as the PalmOS™, located in non-volatile memory 108. The OS may generate event messages in response to actions associated with the operation of device 100. For example, an action may be the occurrence of a signal from an internal clocking device that provides timer functionalities. Alternatively, an action may be associated with input device 110 detecting an interaction between a user-controlled pointer and a widget displayed on a user interface included in display 102. The interaction may include a pointer-down event, a pointer-up event, and a drag event.

A pointer-down event may be associated with an initial contact between a pointer and the user interface, such as when a user initially selects an icon displayed on display 102 with a pointer. A pointer-up event may be associated with a current contact between a pointer and the user interface being removed, such as when a user lifts a pointer off of the user interface. A drag event may be associated with a contact that begins in one location of the user interface and moves across the user interface to a second location, such as when a user moves a pointer across a user interface.

The OS may include an event handler to receive and respond to event messages. The event handler may be implemented in software as a function call to a particular event or set of events based on the user interaction with a widget. In one configuration consistent with certain features related to the present invention, the event message contains information relating to an event, such as information identifying the event itself. The event may be associated with an operation, including, but not limited to, a scroll operation or a selection operation. The event handler may receive information about an operation contained in an event message and the information may be used to assist the event handler in processing the operation.

In one aspect consistent with the present invention, device 100 may be a PDA device operating under the Java™ executable environment for the Connected Limited Device Configuration (“CLDC”) and J2ME™ Mobile Information Device Profile (“MIDP”). Event handling may be implemented by device 100 using a native language such as, for example, the C programming language, or it may be implemented in a hybrid of native and Java™ languages.

In one embodiment consistent with the present invention, a widget may be implemented as a MIDlet having associated native event handlers written in C. A MIDlet is a Java application that conforms to the specifications set out by CLDC and MIDP. Furthermore, event handlers may be written in the C programming language to provide faster response times. In one configuration consistent with the present invention, portions of software reflecting the widget, including those that interface with the MIDlet public Application Programming Interfaces (“APIs”), may be written in the Java™ programming language.

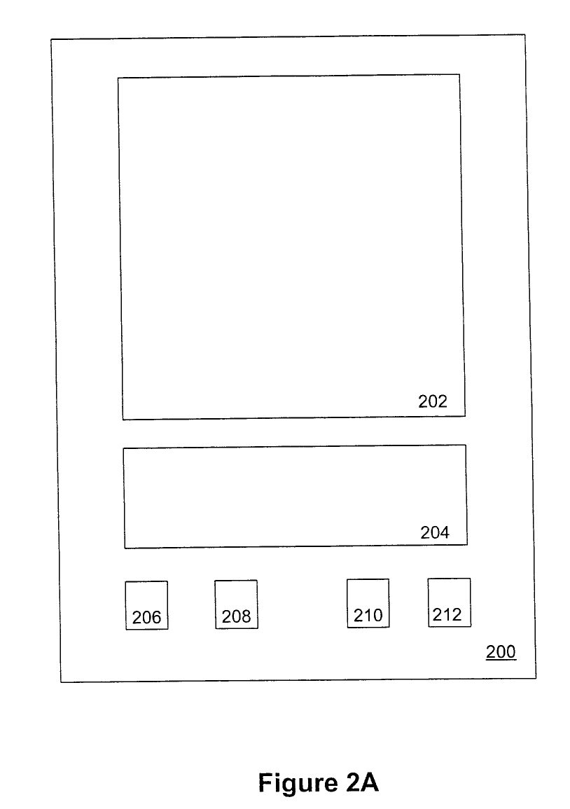

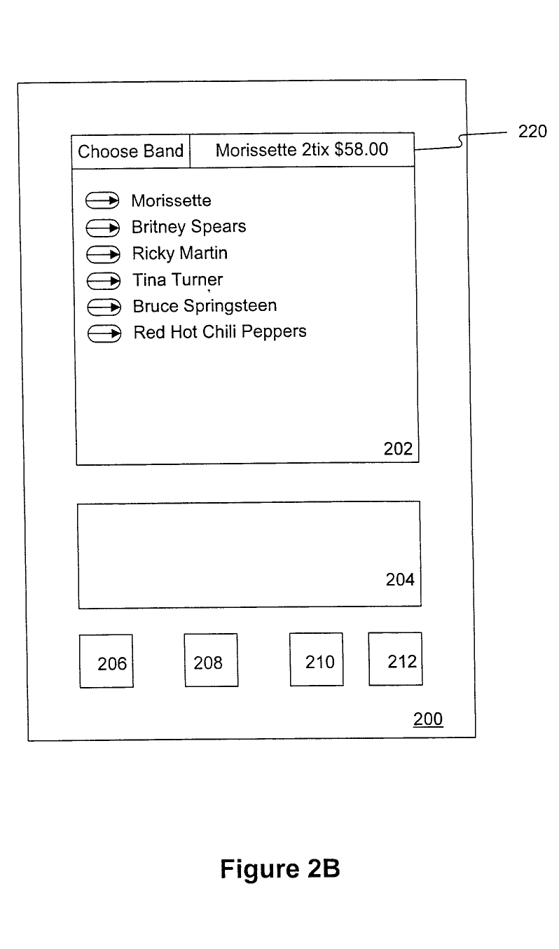

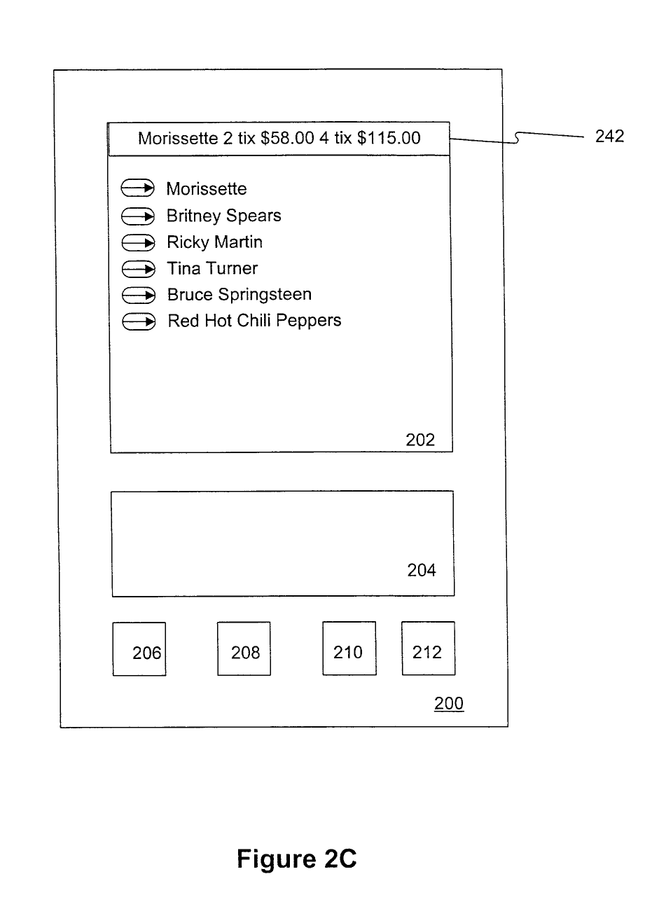

FIG. 2A is a block diagram showing an exemplary PDA 200 in which systems, methods, and articles of manufacture may be implemented. PDA 200 may include display element 202, input region 204, and buttons 206, 208, 210, 212.

Display element 202 may be a pressure-sensitive LCD device. Display element 202 generates (x, y) coordinates in response to user actions, such as a pointer-down event and a pointer-up event. The (x, y) coordinates, which correspond to a physical position where the pointer makes contact with display element 202, may be stored as information included in an event message that may contain information associated with a pointer event.

Input region 204 may be a display area that may be more resistant to wear from exposure to a pointer than display area 202. Further, input region 204 may be used primarily to receive input information from a user-controlled pointer. Additionally, buttons 206, 208, 210, and 212 may be components that allow a user to input information by selecting an appropriate button.

FIG. 2B is a diagram showing the exemplary PDA 200 that is includes an interactive OS, such as the PalmOS™. The PDS 200 shown in FIG. 2B may execute an application including a scrolling ticker, represented by widget 220. Widget 220 may be associated with a contracted ticker that allows a user to scroll text (and images) displayed in display element 202 from right to left (or vice versa). Widget 220 may allow a user to manipulate the information displayed in display element 202 to view a text message (or image display) longer then the width of display element 202. As shown in FIG. 2B, an exemplary list of options related to widget 220 may be displayed in display element 202.

When a user interacts with widget 220 through an action, such as a pointer-down event, PDA 200 may create an event message containing information about the event. For instance, the information may include a position of a pointer during the pointer-down event. Because linear displacement of data displayed in display element 202 may be represented in terms of pixels, the position may be reflected by a (x, y) coordinate represented in pixels. An event message may be associated with a selection operation and a scroll operation.

In one configuration consistent with certain features related to the present invention, PDA 200 may associate a selection operation with a pointer-down event on display element 202 followed by a pointer-up event located on display element 202. For example, a pointer-up event may be associated with a user placing a pointer on widget 220 and immediately lifting the pointer from widget 220. When the event handler receives an event message associated with a selection operation, the event handler may process the selection operation such that widget 220 may expand on display element 202 to allow additional text to be displayed.

Similar to the selection operation, a scroll operation may also be associated with a pointer-down event followed by a pointer-up event. Prior to the pointer-up event, however, PDA 200 may detect a drag event. When the event handler receives an event message associated with a scroll operation, the event handler may process the scroll operation such that the text displayed within widget 220 may move according to the movement of the pointer.

In one configuration consistent with certain features of the present invention, PDA 200 may distinguish a selection operation from a scroll operation based on a pointer displacement (“PD”) and an error threshold (“ET”). PD may be a value associated with an initial and final location of a pointer on display element 202. ET may be a predetermined value that represents a distance between an initial and final pointer location. For example, PDA 200 may interpret an operation as a selection operation rather than a scroll operation when a PD is below the ET. If, on the other hand, PD is determined to be greater than ET, PDA 200 may interpret the operations as a scroll operation instead of a selection operation.

FIG. 2C is a diagram showing PDA 200 with an exemplary widget 242. PDA 200 may operate an interactive OS, such as the PalmOS™ running a scrolling ticker application. The ticker application may present widget 242 with text that scrolls from right to left. The widget may be a scrolling ticker implemented in a horizontal rectangle containing text that scrolls from right to left within the rectangle. Alternatively, the text may scroll in other directions, such as from left to right, top to bottom, bottom to top, and horizontally. In one configuration consistent with certain features of the present invention, if PDA 200 detects a selection operation, widget 242 may contract. If, on the other hand, a scroll operation is detected by PDA 200, the text included in widget 242 may be dragged side-to-side in an operation similar to that described with regard to FIG. 2B.

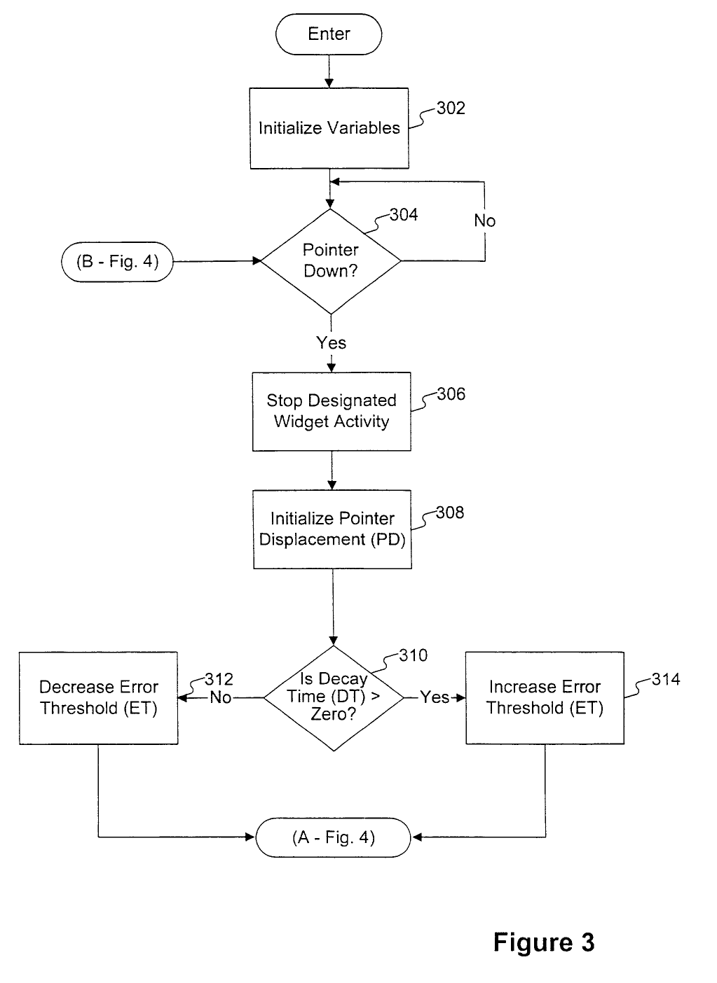

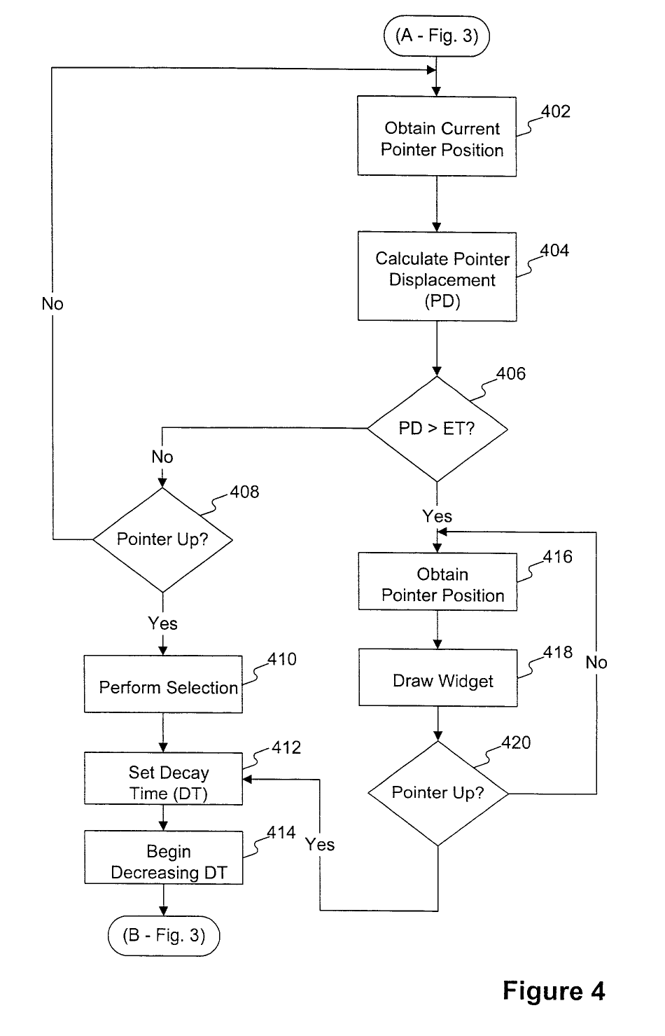

FIGS. 3 and 4 are flow diagrams associated with a method for distinguishing a selection operation from a scrolling operation consistent with certain principles related to the present invention. Although the processes of FIGS. 3 and 4 described below may be associated with the PDA 200 shown in FIG. 2C, one skilled in the art would realize that these processes may be associated with other operating environments, such as the PDAs shown in FIGS. 2A and 2B, without departing from the scope of the invention. In accordance with one aspect of the present invention, the method may be implemented in an MIDP execution environment by processor 106 operating within PDA 200.

To perform the method shown in FIG. 3, PDA 200 may employ a user interface loop interface making use of various operating system features and constructs. For example, threads and/or processes may collect user input events and a single process loop may poll these inputs and process them as they become available. Further, input information, such as user input from buttons 206, 208, 210, and 212 of FIG. 2 may be provided to PDA 200 by way of interrupts generated by input device 110.

As shown, processor 106 may begin the process described in FIG. 3 by initializing selected variables (stage 302). The variables may be state variables that include, for example, an ET and decay time (“DT”) variable. DT may be a variable that is associated with an amount of time a pointer makes continuous contact with display element 202. In one configuration consistent with certain features of the present invention, ET and DT may be initialized to zero. Other state variables may include PD. As previously described, PD may be a distance between two pointer events associated with a pointer and display element 202 (including widget 242).

Methods, systems, and articles of manufacture consistent with certain principles related to the present invention may associate the ET with an unintentional PD. For example, DT may be a value reflecting a time associated with a pointer-down event and may be used by processor 106 to determine whether a user actually intended to move the pointer, or has made a small, unintended PD. DT may be used by PDA 200 to track the time associated with a pointer event. This time can be used to improve the accuracy of a response to user interaction by allowing more or less pointer displacement.

PDA 200 may automatically initialize the variables during compile-time or run-time, based on the type of operating environment implemented. Alternatively, stage 302 may be omitted and the variables initialized as PDA 200 needs them.

After the variables are initialized, PDA 200 may wait for a pointer event by continuously polling display element 202 to detect a pointer event, such as a pointer-down condition (stage 304). If PDA 200 detects a pointer event, such as a pointer-down event (stage 304; YES), a signal for a pointer-down event may be generated. The signal for a pointer-down event may adjust the activity performed within display element 202, such as the scrolling ticker operations displayed by widget 242 (stage 306). For example, PDA 200 may stop text associated with the ticker widget 242 from scrolling. Other activity performed and displayed on display element 202 may not stop, such as the execution and display of a web browser application.

In accordance with an aspect of the present invention, when PDA 200 detects an initial pointer-down event, there may have been no previous pointer events detected. Accordingly, a PD variable may be initialized by processor 106 (stage 308). Next, PDA 200 may evaluate the DT value to determine whether it is equal to a certain value, such as zero (stage 310). One skilled in the art would realize that a value other than zero might be implemented and compared to DT without departing from the scope of the present invention.

If PDA 200 determines that DT is less than zero (stage 310; NO), PDA 200 may decrease the value of ET, but not below zero (stage 312). If the DT associated with the pointer-down an event is less then or equal to zero, then a large amount of time has passed and the operation selected may be considered a scroll operation by PDA 200.

On the other hand, if DT is greater than zero, ET is increased (stage 314). In one embodiment, ET is not incremented if ET meets or exceeds a certain value, such as three pixels. However, a maximum ET may be adjusted or tuned based on characteristics associated with PDA 200 (i.e., the size of display element 202).

Once the ET is adjusted, PDA 200 may determine a current pointer position (stage 402). PDA 200 may determine the current pointer position by a retrieving, collecting, or receiving coordinate data from input device 110.

Following the determination of the current pointer position, PDA 200 may determine the PD associated with the pointer event. PDA 200 may determine PD based on a distance between the current pointer position (obtained in stage 402) and a previously determined pointer position (such as the position of the pointer-down event obtained at stage 304 in FIG. 3). PDA 200 may compare PD to the ET (stage 406). If PD is not greater than ET, then the pointer event may be considered as a pointer-down event by PDA 200, even though some movement of the pointer was detected. If there was no pointer-up event (stage 408; NO), the current pointer position is determined (stage 402), and the process repeats (stages 404-406).

If PDA 200 detects a pointer-up event following the pointer-down event (stage 408), the pointer event may be associated with a selection event. Accordingly, PDA 200 may process the pointer event as a selection operation. In one configuration consistent with the present invention, a selection operation may be used to process a selection of a link or an icon in an application by a user, such as, for example, a web application. For example, PDA 200 may process a selection operation associated with a hyperlink by accessing and displaying information associated with the link through a browser executing on PDA 200. In another aspect of the present invention, a selection event may be associated with widget 242.

Once PDA 200 performs the selection operation, PDA 200 may set DT to a specific value, such as 1000 ticks (stage 412). In the PalmOS™ environment, a tick is a predetermined unit of time. PDA 200 may begin to decrease DT by a predetermined amount in a cyclical manner (i.e., count down) (stage 414). The method continues by returning to FIG. 3 at position “B”.

Referring to stage 406, if PD is greater than ET, PDA 200 may associate the pointer event as a scroll event. Accordingly, PDA 200 may process the pointer event as a scroll operation and the position of the pointer-down event may be determined by PDA 200 in a manner similar to that described with respect to stage 402 (stage 416). PDA 200 may draw the widget on user interface 202 reflecting the movement associated with the scroll operation (stage 418). If PDA 200 detects a pointer-up event (stage 420; YES), then the scroll operation is complete and PDA 200 may set and begin to decrease DT (stages 412-414). If a pointer-up event is not received (stage 420; NO), the scroll operation continues.

It will be apparent to those skilled in the art that various modifications and variations can be made in user interfaces and methods consistent with the principles of the present invention without departing from the scope or spirit of the invention. Although several embodiments have been described, other variations are possible consistent with the principles of the present invention. Other embodiments of the invention will be apparent to those skilled in the art from consideration of the specification and practice of the disclosed embodiments. The specification and examples are exemplary only, and the true scope and spirit of the invention is defined by the following claims and their equivalents.

For example, the process stages shown in FIGS. 3 and 4 may be performed in different sequences. Also, the configuration of PDA 200 shown in FIGS. 2A-2C may be adjusted without departing from the scope of the invention. For instance, buttons 206-212 may be removed. Further, additional features of PDA 200 may be added, deleted, or modified as well.

What is claimed is:

1. A method for distinguishing between user operations for an interactive display device, comprising:
detecting interactions between a user-controlled pointer and the interactive display device to establish pointer events;
measuring a position displacement as a distance between a first pointer event and a second pointer event; and
comparing the position displacement to an error threshold to distinguish between user operation.

2. The method of claim 1, wherein the user operations may be selected from a set comprising a scroll operation and a selection operation.

3. The method of claim 1, further comprising:
calculating a decay time associated with each established pointer event.

4. The method of claim 3, further comprising:
adjusting the error threshold based on the decay time.

5. A method comprising:
detecting interactions between a user-controlled pointer and an interactive display device to form pointer events;
receiving separately a first pointer event and a second pointer event;
calculating a pointer displacement based on a position of the user-controlled pointer upon occurrence of the first pointer event and a position of the user-controlled pointer-upon occurrence of the second pointer event; and
comparing the pointer displacement to an error threshold to determine a desired user operation associated with the first and second pointer events.

6. The method according to claim 5, further comprising:
stopping activity associated with a widget displayed on the user interface on receiving the first pointer event.

7. The method according to claim 5, further comprising:
determining a decay time based on an elapsed time between occurrence of the first pointer event and occurrence of the second pointer event.

8. The method according to claim 7, further comprising:
increasing the error threshold if the decay time is above a predetermined value.

9. The method according to claim 7, further comprising:
decreasing the error threshold if the decay time is less than a predetermined value.

10. The method according to claim 5, wherein the desired user operation is one of a scroll operation and a selection operation.

11. The method according to claim 10, further comprising:
determining that the desired user operation is a selection operation when the error threshold is less than the pointer displacement.

12. The method according to claim 10, further comprising:
determining that the desired user operation is a scroll operation when the error threshold is greater than the pointer displacement.

13. A method for distinguishing between user operations for an interactive display device, comprising:
detecting occurrences involving interactions between a user-controlled pointer and an interactive display device to form pointer events;
calculating a pointer displacement based on a position of the user-controlled pointer upon occurrence of a first pointer event and a position of the user-controlled pointer upon occurrence of a second pointer event;
comparing the pointer displacement to an error threshold;
performing a selection operation if pointer displacement is less than or equal to the error threshold; and
performing a scroll operation if pointer displacement is greater than the error threshold.

14. A method for determining a desired user operation performed by a processor in a personal digital assistant having an input device comprising a pointer and a pressure sensitive surface for receiving user input and a display, the method comprising:
detecting input events associated with the pressure sensitive surface, each input event have a location relative to at least one point of the pressure sensitive surface;
determining a position displacement as a distance between a first location associated with a first input event and a second location associated with a second input event; and
comparing the position displacement to an error threshold to determine the desired user operation.

15. The method of claim 14, wherein the desired user operation includes a scroll operation and a selection operation.

16. The method of claim 14, further comprising:
determining a decay time based on the length of time elapsed between the first and second pointer events.

17. The method of claim 16, further comprising:
adjusting the error threshold based on the decay time.

18. A computer-readable medium including instructions for performing a method, when executed by a processor, the method comprising:
displaying at least one graphical interface object that is responsive to a user operation associated with a pointer;
detecting a first pointer event and a second pointer event;
determining a pointer displacement based on a position of the pointer at the first pointer event and a position of the pointer at the second pointer event;
determining an error threshold based on an elapsed time between the first pointer event and the second pointer event; and
identifying the user operation based on the error threshold and pointer displacement.

19. A system for distinguishing between user operations for an interactive display device, comprising:
means for detecting interactions between a user-controlled pointer and the interactive display device to establish pointer events;
means for measuring a position displacement as a distance between a first pointer event and a second pointer event; and
means for comparing the position displacement to an error threshold to distinguish between user operation.

20. The system of claim 19, wherein the user operations may be selected from a set comprising a scroll operation and a selection operation.

21. The system of claim 19, further comprising:
means for calculating a decay time associated with each established pointer event.

22. The system of claim 21, further comprising:
means for adjusting the error threshold based on the decay time.
